(19) United States
(12) Patent Application Publication
(10) Pub. No.: US 2020/0037142 A1
(43) Pub. Date: Jan. 30, 2020

(54) System, Method, and Apparatus for Communicating Emergency Information

(71) Applicant: Eddie B. Lofton, Suwanee, GA (US)

(72) Inventor: Eddie B. Lofton, Suwanee, GA (US)

(21) Appl. No.: 16/522,748

(22) Filed: Jul. 26, 2019

Related U.S. Application Data
(60) Provisional application No. 62/720,150, filed on Aug. 21, 2018.
(60) Provisional application No. 62/703,733, filed on Jul. 26, 2018.

(51) Int. Cl. H04W 4/90; H04W 76/50; H04W 4/029; H04W 4/38; H04M 3/51; H04M 1/725; G08B 13/16

(52) U.S. Cl. CPC H04W 4/90; H04W 76/50; H04W 4/029; H04M 2242/30; H04M 3/5116; H04M 1/72577; G08B 13/1672; H04W 4/38

(57) ABSTRACT

A system for communicating emergency information to one or more user devices includes a computer for communicating to the one or more user devices (e.g. smartphones). When a situation is encountered (e.g. a shooter, a person with a knife, a fire), the computer communicates with the user devices local to the situation to place them in a secure mode, dimming their displays, quieting the user devices, providing efficient communication tools, and presenting update information regarding the situation such as location of an invader or fire, escape routes. Further, after entering secure mode, audio is captured from the device and used by the computer to determine a location of a gunshot.

### CROSS-REFERENCE TO RELATED APPLICATION

This application claims the benefit of U.S. provisional applications no. 62/720,150 filed on Aug. 21, 2018 and U.S. provisional applications no. 62/703,733 filed on Jul. 26, 2018, the disclosure of which are incorporated by reference.

### FIELD

This invention relates to the field of safety and more particularly to a system for communications during an event such as an active shooter.

### BACKGROUND

It is hard to read a newspaper or watch a news program without learning that someone has entered a facility with a gun and either shot others or attempted/planned to shoot others.

Once shots are fired, people in those locations often panic, causing further bodily harm to each other or becoming targets of the shooter.

Often, one or more persons who can still think logically under such extreme circumstances take evasive action, closing and locking doors, hiding others in a closet, using a cellphone to contact administration/authorities, etc., but it is often difficult to communicate in such a chaotic environment. Further, a person using their cellphone often makes that person a target of the shooter, as the cellphone illuminates the person's face and body making them easier to see and, therefore, shoot. Still further, as one course of action is to hide, for example to hide in a closet, many will not think to silence their cellphone ringer and, as family and friends learn of the event, it is likely that many incoming calls will occur.

Simple communications become difficult during such chaos. In some situations, voice communications is not possible due to the need to hide or pretend that you have already been shot. Text messaging may be the best solution, but the victim may not be able to think clearly and describe exactly what is happening.

What is needed is a system that will provide streamlined communications while reducing the potential of making a person becoming a target of a shooter, etc.

### SUMMARY

In one embodiment, a system is disclosed including a computer and one or more user devices (e.g. smartphones). When a situation is encountered (e.g. a shooter, a person with a knife, a fire), the computer communicates with the user devices to place them in a secure mode, dimming their displays, quieting the user devices, and presenting update information regarding the situation such as location of an invader or fire, escape routes, and efficient communication tools.

In another embodiment, a system for communicating emergency information is disclosed, including a computer, a plurality of user devices, and software running on the computer. Upon detecting an alarm, the software running on the computer causing the computer to communicate the alarm to each of the user devices. Upon receiving the alarm by each user device of the plurality of user devices, software running on the each user devices causes the each user device to set a brightness of a display of the each user device to a low brightness and to disable audio output of the each user device. The software running on the each user devices also causes the each user device to display a status of the alarm and to provide quick action icons.

In another embodiment, a method for communicating emergency information is disclosed, including loading a safety application on a user device then, upon detecting an alarm, communicating the alarm from a computer to the user device. Upon receiving the alarm by the safety application running on the user device, the safety application setting a brightness of a display of the user device to a low brightness and the safety application disabling audio output of the user device, the safety application further displaying a status of the alarm on the display and providing quick action icons on the display.

In another embodiment, a system for communicating emergency information is disclosed, including a computer, a plurality of user devices, and software running on the computer. Upon detecting an alarm, the software causing the computer to communicate the alarm to each of the user devices. Then, upon receiving the alarm by each user device of the plurality of user devices, software running on the each user devices causes the each user device to set a brightness of a display of the each user device to a low brightness, to disable audio output of the each user device, to display a status of the alarm, to initiate capture audio from a microphone of the each user device, to read a device location of the each user device from a global positioning subsystem of the each user device, and, in some embodiments, to periodically transmit the audio and the device location to the computer. In some other embodiments, the audio is analyzed for specific sounds (e.g. gunshots) at the user device and upon detecting the specific sounds (e.g. gunshots), an indication of the specific sound as well as the device location, and/or the current time, and/or a volume level of the specific sound is transmitted to the computer for further analysis and triangulation.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a map of an exemplary building utilizing the system for communicating emergency information.

FIG. 1A illustrates a second plan view of a map of an exemplary building utilizing the system for communicating emergency information.

FIG. 1B illustrates a second plan view of a map of an open area utilizing the system for communicating emergency information.

FIG. 1C illustrates a noise pattern of an exemplary gunshot sound.

FIG. 2 illustrates a schematic view of a typical smartphone.

FIG. 3 illustrates a schematic view of a typical computer system of the system for communicating emergency information.

FIG. 4 illustrates a first typical user interface of the system for communicating emergency information.

FIGS. 5 and 5A illustrate typical user interfaces of the system for communicating emergency information.

FIG. 6 illustrates an exemplary dataset for provisioning of the system for communicating emergency information.

FIG. 6A illustrates a second exemplary dataset for provisioning of the system for communicating emergency information.

FIG. 7 illustrates an exemplary program flow for operation of the system for communicating emergency information.

FIG. 7A illustrates a second exemplary program flow for operation of the system for communicating emergency information.

FIG. 7B illustrates a third exemplary program flow for operation of the system for communicating emergency information.

FIG. 8 illustrates a plan view of a map of the exemplary building utilizing the system for communicating emergency information after an event has occurred.

FIG. 9 illustrates a schematic view of the system for communicating emergency information.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Once an event such as an active shooter, fire, flood, tornado, etc., occurs, there is an immediate need for clear and efficient communications. For example, in a school setting or other institution such as an office building, when an event occurs, communications is essential to help authorities keep students, workers, employees, staff, and others as safe as possible. In recent years, many employees and students have cellular phones in their possession.

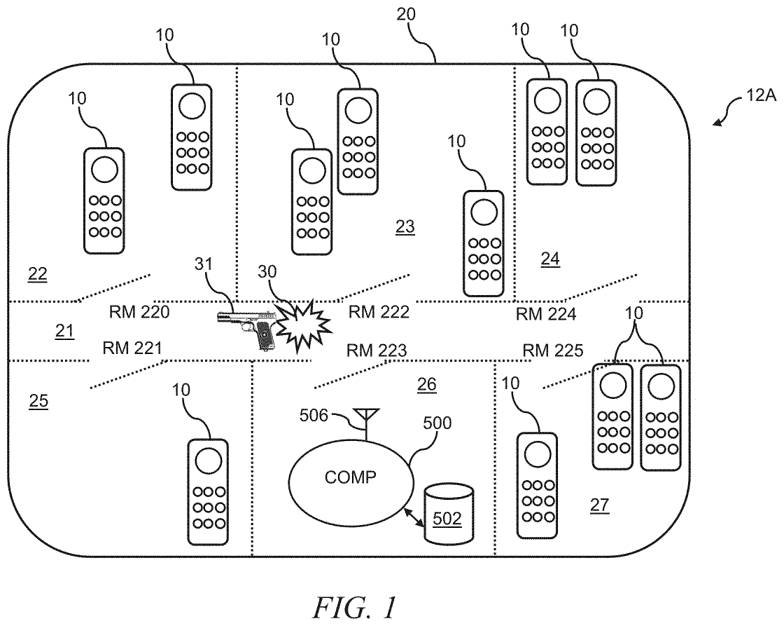

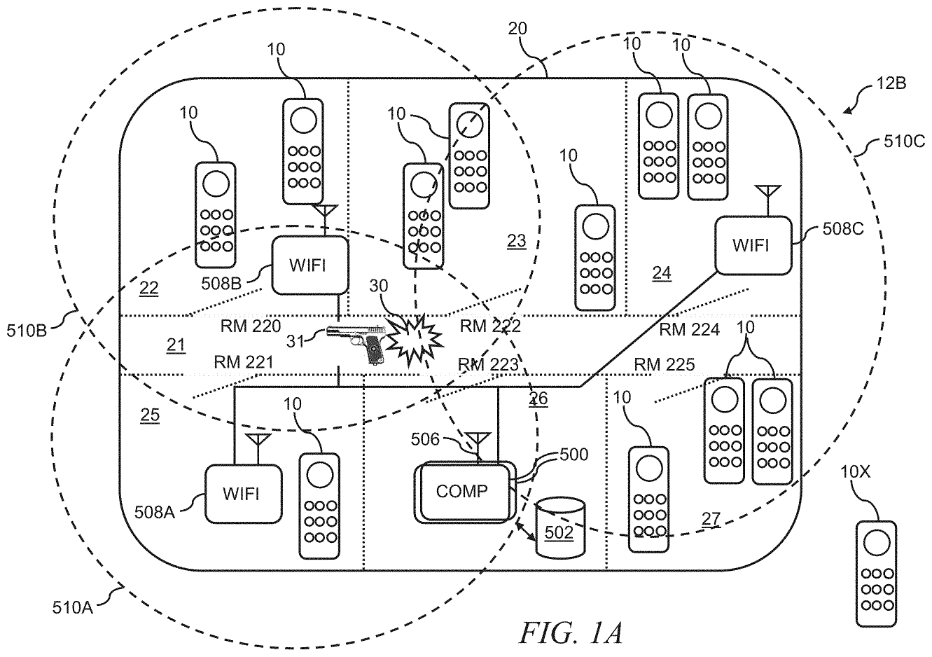

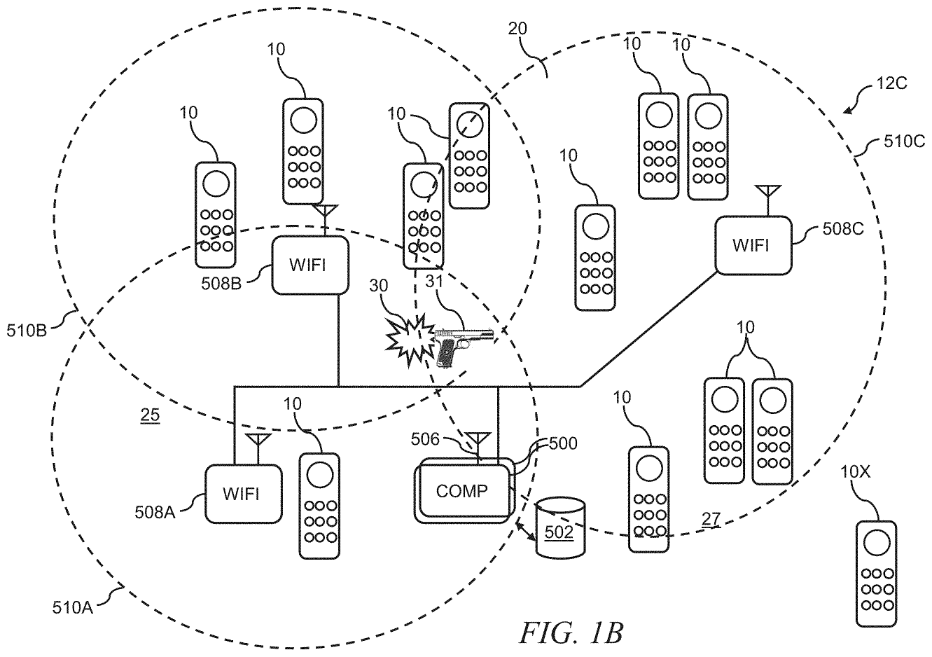

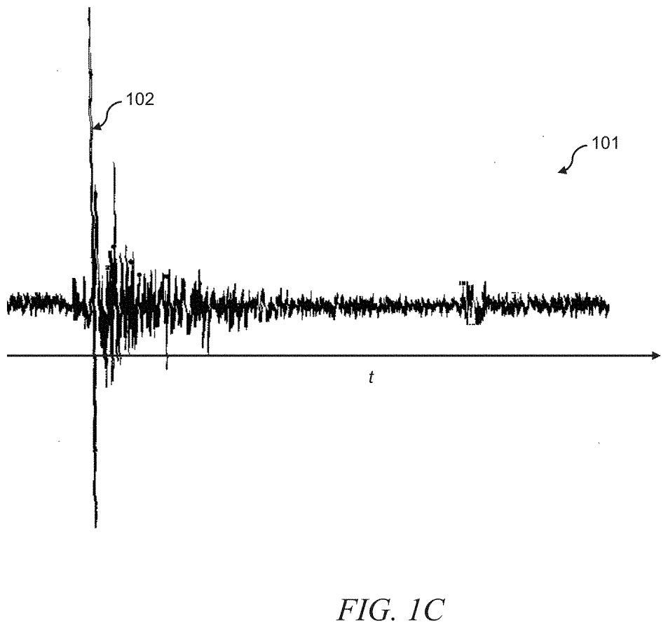

Referring to FIG. 1, a plan view of a map 12A of an exemplary building utilizing the exemplary system for communicating emergency information is shown. In this example, a building 20 is shown having multiple rooms 22/23/24/25/26/27 connected by a hallway 21, perhaps a school, office, church, etc. There a people in the building 20 (not shown for clarity reasons), each having a device that is capable of communicating such as a smartphone 10 (many workers, students, worshipers have and carry smartphones 10). Note that, although a smartphone 10 is used as an example throughout this description, it is fully anticipated that any user device be used in place of the smartphone 10 as long as a connection is possible to the computer 500, typically a wireless connection. Other examples of user devices include, but are not limited to, smartwatches, smart eyewear, smart earpieces, tablet computers, notebook computers, electronic books, desktop computers, etc. In some embodiments, a wired connection is also anticipated, as in the case of desktop computers.

Note also, although a building 20 is shown, it is anticipated that the exemplary system for communicating emergency information be deployed in any area, confined or not, including stadiums, ball parks, parks, public transportation locations (e.g. buses, planes, trains, taxicabs, subway, ferries), downtown areas, etc.

In this example, there is an incident. An invader 30 has entered the building 20 that should not be in the building 20, perhaps someone who is shooting at those within the building 20.

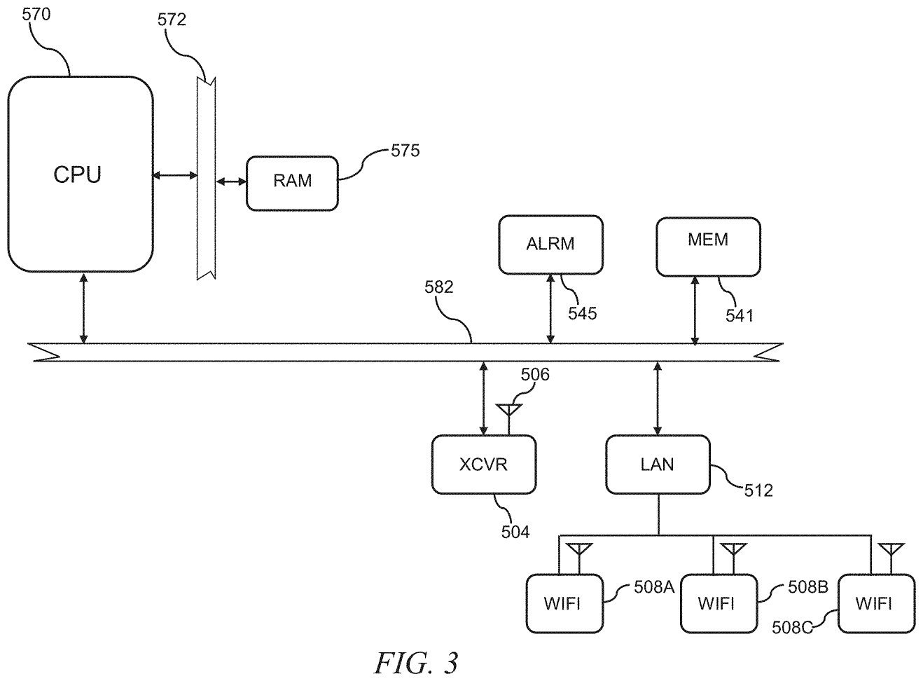

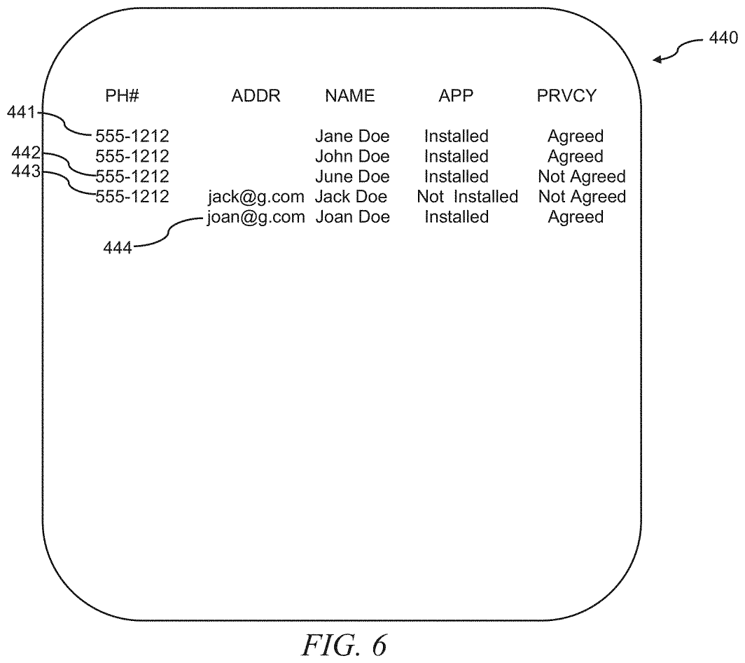

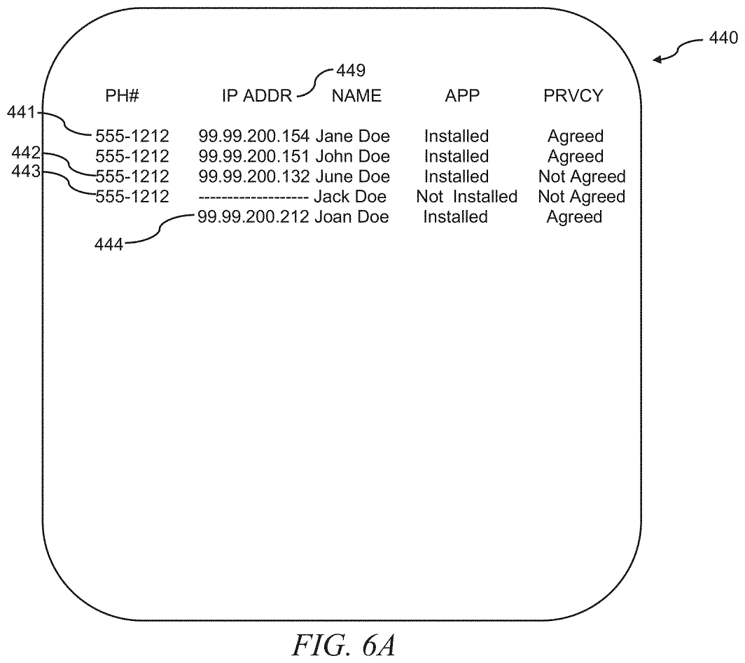

The system for communicating emergency information has a computer 500 (in some embodiments, one or more computers 500 are networked together and cooperate to share information and make decisions) either within the building 20 or external to the building 20. The computer 500 has storage 502 for storing data such as a list of the devices 440 of people/students who may be within the building (see FIGS. 6 and 6A) and has access to a local area or wide area network through a transceiver 504 (see FIG. 3) and antenna 506.

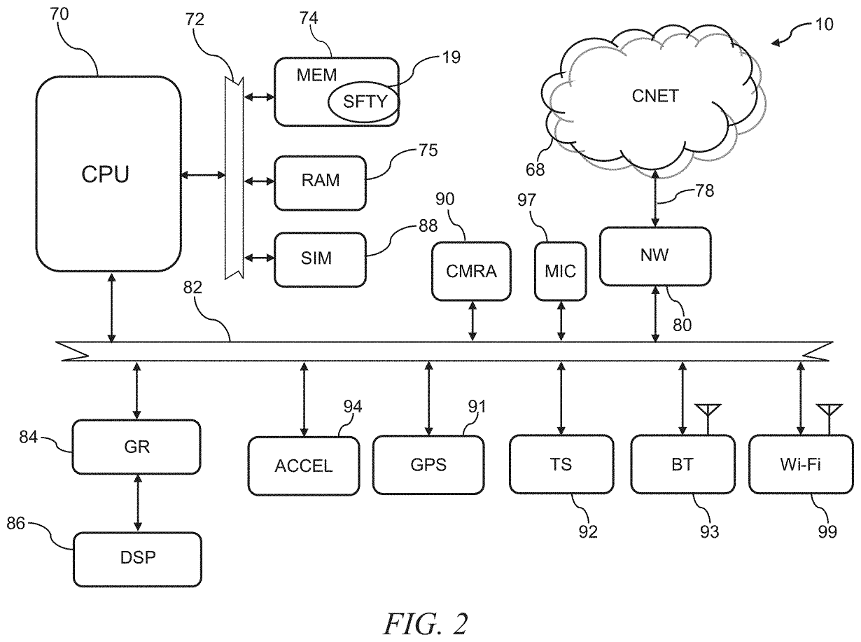

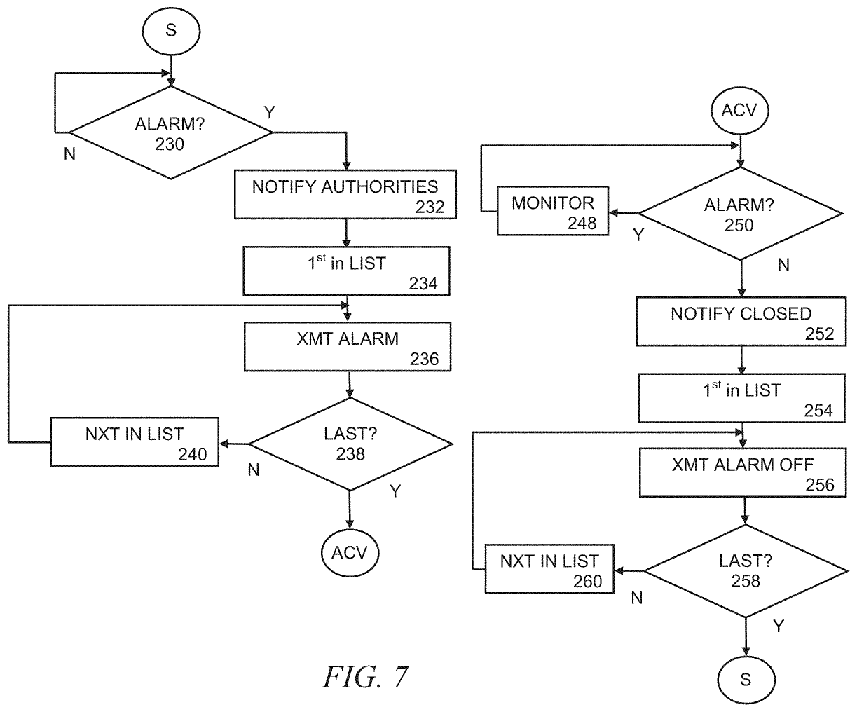

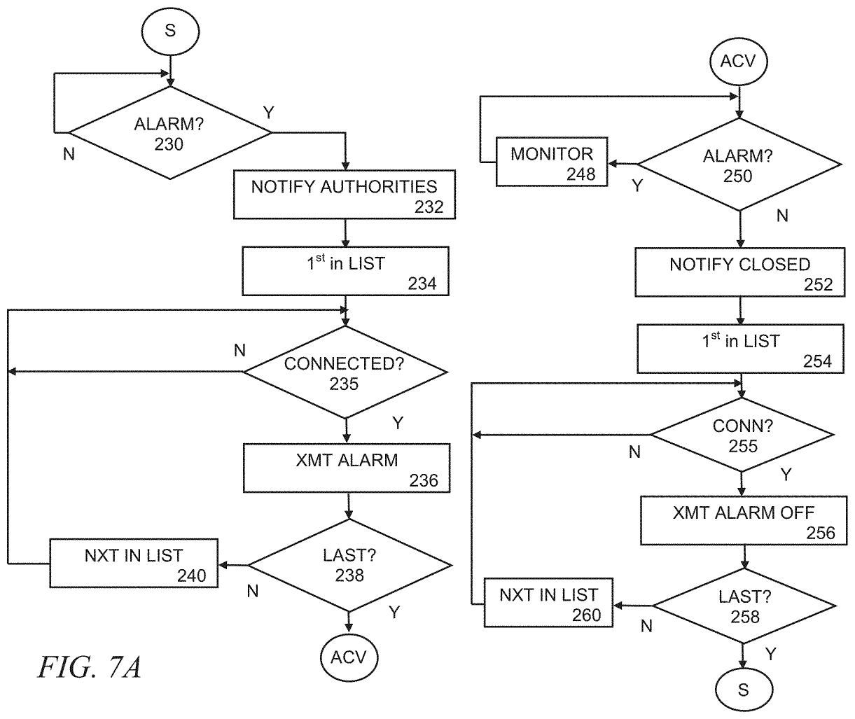

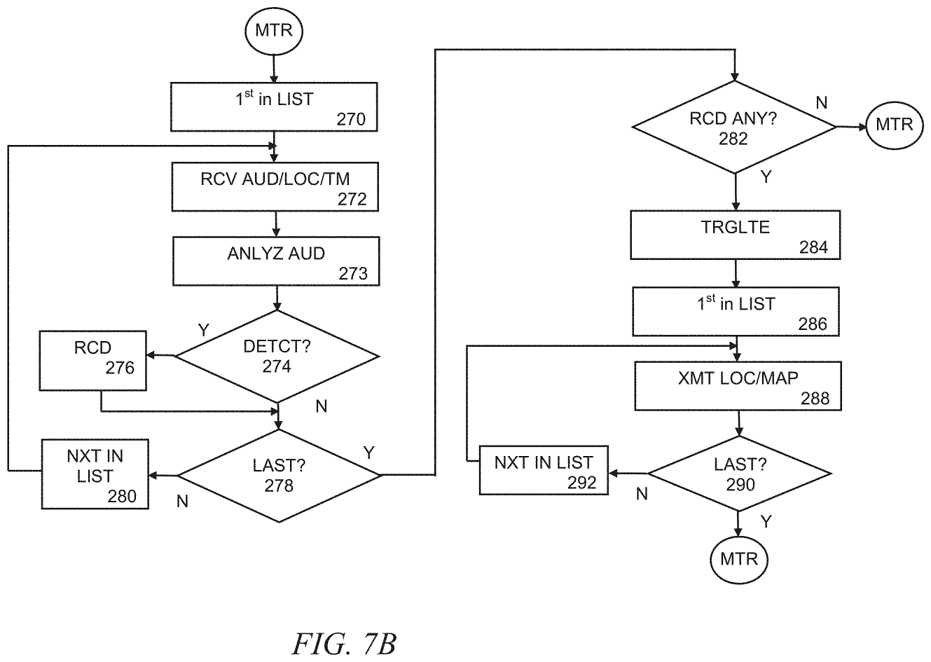

As shown in FIGS. 7 and 7A, when an alarm is signaled (e.g. the invader 30 has entered the building 20 and something of concern has happened, perhaps the invader 30 is shooting at those within the building 20) an application running on the computer 500 communicates the alarm to each user device (e.g. smartphone 10) on the list of devices 440. Responsive to this communication, a safety application 19 (see FIG. 2) running on each of the user devices (e.g. smartphones 10) enters a lock-down mode in which personal safety becomes the primary goal. For improved safety, the safety application 19 controls each smartphone 10 to mute the ringer and dim the display to make it more difficult for the invader 30 to locate at least some of the people within the building 20. For example, if a person is hiding in a closet and their smartphone 10 rings and the display of the smartphone 10 illuminates brightly and the invader 30 is nearby, the invader 30 will be attracted to the closet and may take action against the person who is hiding in the closet.

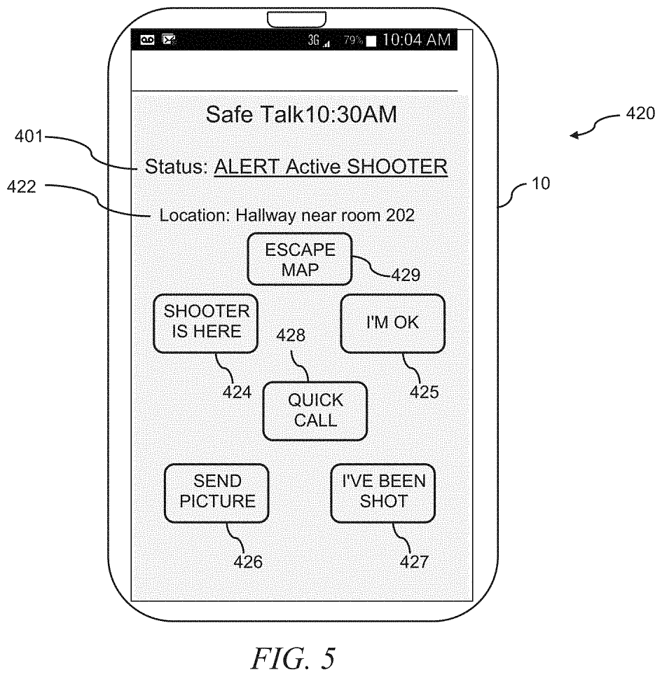

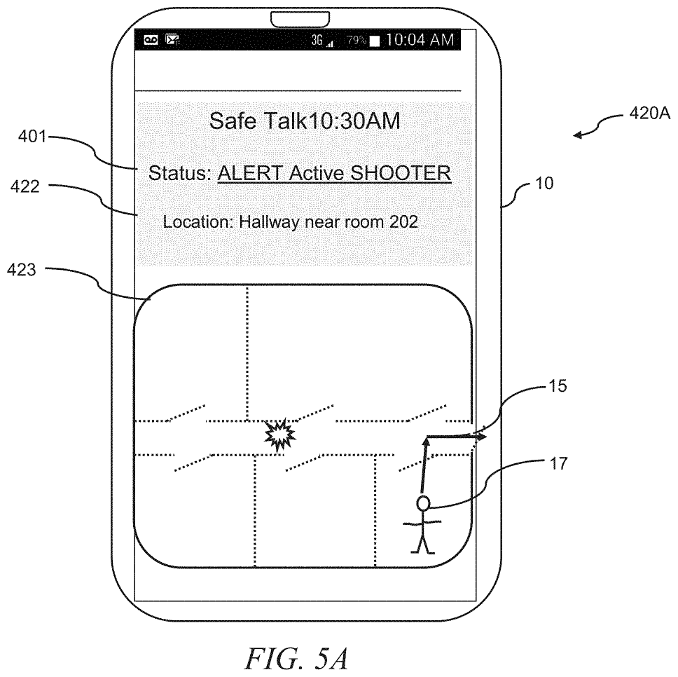

Next, the safety application 19 presents a status screen 420 indicating a status of the incident 401, perhaps a location 422 of the invader 30, and quick communication buttons for informing others regarding the status of the person associated with the smartphone 10 (see FIG. 5).

While the safety application 19 is in lock-down mode, the safety application 19 attempts to locate the invader 30 using sensors of the smartphone 10. For example, if the invader 30 is using a gun 31, the safety application 19 on each smartphone 10 uses a microphone 97 (see FIG. 2) of the smartphone 10 to listen for gunshots. When a gunshot sound pattern 102 (see FIG. 1C) of a sound pattern 101 (see FIG. 1C) is received by a microphone (see FIG. 2) and detected by the safety applications 19, each safety application 19 transmits a measurement of volume of the detected gunshot along with a location of the associated smartphone 10, and in some embodiments a time that the gunshot was detected as most smartphones 10 have very accurate time clocks. The computer 500 receives many of these transmissions and, by comparing the measurements of volume from the set of data received at the same time and/or by comparing the time that each smartphone 10 detected the sound of gunshots with respect to the location of each of the smartphones 10; the computer 500 approximates the location of the invader 30. In some embodiments, the computer 500 relays the location of the invader 30 and relays the location to the safety application 19 running on each of the smartphones. The safety application, then, informs each person of the approximate location of the gunshot. In some embodiments, the computer 500 informs the authorities of the approximate location of the invader 30. For example, each registered person receives notice from the safety application 19 that there is an active shooter and the shooter's suspected location. Although the relative volume of the gunshot sounds is useful in triangulating the location of the gunshots, volume is often affected by room acoustics and room dividers/doors. Since smartphones 10 have very accurate time keeping, using the time that each smartphone detects the sound of the gunshot is often more accurate during triangulation as a smartphone 10 further from the shooter will receive the sound at a time delayed from a smartphone 10 closer to the shooter based upon the speed of sound in air.

Further, in some embodiments, the safety application 19 monitors locations of the user devices (smartphones 10) and/or other sensors to detect movement and speed of movement of the smartphones 10 (e.g. accelerometers) and hence movements of the people/students. This data is forwarded to the computer 500. By collecting such data from multiple smartphones 10, the computer 500 analyzes the data to find clumps of people sharing the same activity such as running or not moving an inch. Assumptions are then made as to why the people are running or why the people are remaining still to help determine a location of the invader 30.

In some embodiments, the camera 90 (see FIG. 2) of each user device (smartphone 10) is monitored and image data forwarded to the computer 500 where images/video are stored in the data storage 502 to record activities and/or to help officials understand what is happening. For example, if the camera 90 forwards a very dark image, perhaps the person is hiding in a closet. If the image from the camera 90 shows blood, perhaps the person or one near the person has been shot, etc. In some embodiments, when the invader 30 is close to the smartphone 10, the camera 90 is used to record and detect any flash of light from a gunshot.

Referring now to FIG. 1A, a plan view of a second map 12B of an exemplary building utilizing the exemplary system for communicating emergency information is shown. In this example, the building 20 is shown having the same multiple rooms 22/23/24/25/26/27 connected by a hallway 21, perhaps a school, office, church, etc. There a people in the building 20 (not shown for clarity reasons), each having a device that is capable of communicating such as a smartphone 10 (many workers, students, worshipers have and carry smartphones 10). Note that, although a smartphone 10 is used as an example throughout this description, it is fully anticipated that any user device be used in place of the smartphone 10 as long as a connection is possible between the device and the computer 500, typically a wireless connection. Other examples of user devices include, but are not limited to, smartwatches, smart eyewear, smart earpieces, tablet computers, notebook computers, electronic books, desktop computers, etc. In some embodiments, a wired connection is also anticipated, as in the case of desktop computers.

In this example, there is an incident. An invader 30 has entered the building 20 that should not be in the building 20, perhaps someone who is shooting at those within the building 20 using a gun 31.

The system for communicating emergency information has a computer 500 (in some embodiments, one or more computers 500 are networked together and cooperate to share information and make decisions) either within the building 20 or external to the building 20. The computer 500 has storage 502 for storing data such as a list of the devices 440 of people who may be within the building (see FIGS. 6 and 6A) and has access to a local area or wide area network through a transceiver 504 (see FIG. 3) and antenna 506 or through a set of local radio transceivers 508A/508B/508C (e.g. Wi-Fi transceivers). Note that any number of radio transceivers 508A/508B/508C is anticipated, including zero and one.

Note that each of the radio transceivers 508A/508B/508C has a coverage area 510A/510B/510C. Knowing which smartphone 10 is connected to which radio transceivers 508A/508B/508C will also help provide location information of each smartphone 10. Note that one smartphone 10X is either out of range of the radio transceivers 508A/508B/508C and/or is not connected (e.g. off or in airplane mode).

As shown in FIGS. 7 and 7A, when an alarm is signaled (e.g. the invader 30 has entered the building 20 and something of concern has happened, perhaps the invader 30 is shooting at those within the building 20) an application running on the computer 500 communicates the alarm to each user device (e.g. smartphone 10) on the list of devices 440 through a connection to the radio transceivers 508A/508B/508C. Responsive to this communication, a safety application 19 (see FIG. 2) running on each of the user devices (e.g. smartphones 10) enters a lock-down mode in which personal safety becomes the primary goal. For improved safety, the safety application 19 controls each smartphone 10 to mute the ringer and dim the display to make it more difficult for the invader 30 to locate at least some of the people within the building 20. For example, if a person is hiding in a closet and their smartphone 10 rings and the display of the smartphone 10 illuminates brightly and the invader 30 is nearby, the invader 30 will be attracted to the closet and may take action against the person who is hiding in the closet.

Next, the safety application 19 presents a status screen 420 indicating a status of the incident 401, perhaps a location 422 of the invader 30, and quick communication buttons for informing others what regarding status of the person of the smartphone 10 (see FIG. 5).

While the safety application 19 is in lock-down mode, the safety application 19 attempts to locate the invader 30 using sensors of the smartphone 10. For example, if the invader 30 is using a gun (not shown for clarity reasons), the safety application 19 on each smartphone 10 uses a microphone 97 (see FIG. 2) of the smartphone 10 to listen for gunshots. When a noise that sounds like a gunshot is detected by the safety applications 19, each, through the smartphones 10, transmits a measurement of volume of the detected gunshot along with a location of the associated smartphone 10. The computer 500 receives many of these measurements of volume and, by comparing the measurements of volume from the set of data received at the same time and/or the arrival time difference from the set of data received from multiple smartphones 10; the computer 500 approximates the location of the invader 30 and informs each person through the safety application 19 of the approximate location and, in some embodiments, informs the authorities of the approximate location. For example, each person receives notice that there is an active shooter and the shooter's suspected location.

Further, in some embodiments, the safety application 19 monitors locations of the user devices (smartphones 10) and/or other sensors to detect movement and speed of movement of the smartphones 10 (e.g. using global positioning systems 91 and/or accelerometers 94) and hence, movement of the people. This data is forwarded to the computer 500. By collecting such data from multiple smartphones 10, the computer 500 analyzes the data to find clumps of people sharing the same activity such as running or not moving an inch. Assumptions are then made as to why the people are running or are still, and these assumptions help determine a location of the invader 30.

In some embodiments, the camera 90 (see FIG. 2) of each user device (smartphone 10) is monitored and image data forwarded to the computer 500 where images/video are stored in the data storage 502 to record activities and/or to help officials understand what is happening. For example, if the camera 90 forwards a very dark image, perhaps the person is hiding in a closet. If the image from the camera 90 shows blood, perhaps the person or one near the person has been shot, etc. In some embodiments, when the invader 30 is close to the smartphone 10, the camera 90 is used to record and detect any flash of light from a gunshot.

Referring now to FIG. 1B, a plan view of a second map 12C of an exemplary open area utilizing the exemplary system for communicating emergency information is shown. In this example, the open is, for example, a stadium, ballpark, park, field, campground, etc. There are people in the open area (not shown for clarity reasons), each having a device that is capable of communicating such as a smartphone 10 (many attendees, campers, sports fans, etc., have and carry smartphones 10). Note that, although a smartphone 10 is used as an example throughout this description, it is fully anticipated that any user device be used in place of the smartphone 10 as long as a connection is possible between the device and the computer 500, typically a wireless connection. Other examples of user devices include, but are not limited to, smartwatches, smart eyewear, smart earpieces, tablet computers, notebook computers, electronic books, desktop computers, etc. In some embodiments, a wired connection is also anticipated, as in the case of desktop computers.

In this example, there is an incident. An invader 30 is in the open area, perhaps someone who is shooting at people within the open area with a gun 31.

The system for communicating emergency information has a computer 500 (in some embodiments, one or more computers 500 are networked together and cooperate to share information and make decisions). The computer 500 has storage 502 for storing data such as a list of the devices 440 of people who are registered (see FIGS. 6 and 6A) and has access to a local area or wide area network through a transceiver 504 (see FIG. 3) and antenna 506 or through a set of local radio transceivers 508A/508B/508C (e.g. Wi-Fi transceivers). Note that any number of radio transceivers 508A/508B/508C is anticipated, including zero and one.

Note that each of the radio transceivers 508A/508B/508C has a coverage area 510A/510B/510C. Knowing which smartphone 10 is connected to which radio transceivers 508A/508B/508C will also help provide location information of each smartphone 10.

As shown in FIGS. 7 and 7A, when an alarm is signaled (e.g. the invader 30 has done something of concern, perhaps the invader 30 is shooting at those within the open area) an application running on the computer 500 communicates the alarm to each user device (e.g. smartphone 10) that is connected through a connection to the radio transceivers 508A/508B/508C. Responsive to this communication, a safety application 19 (see FIG. 2) running on each of the user devices (e.g. smartphones 10) enters a lock-down mode in which personal safety becomes the primary goal. For improved safety, the safety application 19 controls each smartphone 10 to mute the ringer and dim the display to make it more difficult for the invader 30 to locate at least some of the people within the outside area. For example, if a person is hiding i and their smartphone 10 rings and the display of the smartphone 10 illuminates brightly and the invader 30 is nearby, the invader 30 will be attracted to the person who is hiding.

Next, the safety application 19 presents a status screen 420 indicating a status of the incident 401, perhaps a location 422 of the invader 30, and quick communication buttons for informing others what regarding status of the person of the smartphone 10 (see FIG. 5).

While the safety application 19 is in lock-down mode, the safety application 19 attempts to locate the invader 30 using sensors of the smartphone 10. For example, if the invader 30 is using a gun 31, the safety application 19 on each smartphone 10 uses a microphone 97 (see FIG. 2) of the smartphone 10 to listen for gunshots. When a noise that sounds like a gunshot (see FIG. 1C) is detected by the safety applications 19, each safety application 19 transmits a measurement of volume of the detected gunshot along with a location and/or time of the associated smartphone 10 through one or more transceivers 80/93/99 of the smartphones 10. The computer 500 receives many of these measurements of volume and/or location and/or time. The computer compares the measurements of volume/location/time from the set of data received from several smartphones and approximates the location of the invader 30. Once a location of the invader 30 is determined, the computer 500 informs each person through the safety application 19 of the approximate location and, in some embodiments, also informs the authorities of the approximate location. For example, each person receives notice that there is an active shooter and the shooter's suspected location.

Further, in some embodiments, the safety application 19 monitors locations of the user devices (smartphones 10) and/or other sensors to detect movement and speed of movement of the smartphones 10 (e.g. using global positioning system 91 and/or accelerometers 94) and hence, movement of the people. This data is forwarded to the computer 500. By collecting such data from multiple smartphones 10, the computer 500 analyzes the data to find clumps of people sharing the same activity such as running or not moving an inch. Assumptions are then made (e.g. using heuristics or artificial intelligence) as to why the people are running or are still and these assumptions help determine a location of the invader 30.

In some embodiments, the camera 90 (see FIG. 2) of each user device (smartphone 10) is monitored and image data forwarded to the computer 500 where images/video are stored in the data storage 502 to record activities and/or to help officials understand what is happening. For example, if the camera 90 forwards a very dark image, perhaps the person is hiding. If the image from the camera 90 shows blood, perhaps the person or one near the person has been shot, etc. In some embodiments, when the invader 30 is close to the smartphone 10, the camera 90 is used to record and detect any flash of light from a gunshot.

Referring to FIG. 2, a schematic view of a typical device, a smartphone 10, is shown though other portable (wearable or carried with a person) end-user devices such as tablet computers, smartwatches, smart ear buds, smart eyewear, personal fitness devices, etc., are fully anticipated. Although any end-user device is anticipated, for clarity purposes, a smartphone 10 of the user will be used in the remainder of the description.

The example smartphone 10 represents a typical device and is shown in one form with a sample set of features. Different architectures are known that accomplish similar results in a similar fashion and the present invention is not limited in any way to any particular smartphone 10 architecture or implementation. In this exemplary smartphone 10, a processor 70 executes or runs programs in a random-access memory 75. The programs are generally stored within a persistent memory 74 and loaded into the random-access memory 75 when needed. Also accessible by the processor 70 is a SIM card 88 (subscriber information module) having a subscriber identification and often persistent storage. The processor 70 is any processor, typically a processor designed for phones. The persistent memory 74, random-access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary smartphones 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on the display 86. The touch screen interface 92 provides navigation and selection features.

It is fully anticipated that any wireless interface is used to communicate between the smartphones 10 and the computer 500 including, but not limited to, Wi-Fi, Bluetooth, and cellular data including, but not limited to GSM, TDMA, LTE, etc. It is also fully anticipated that the communication path adapts to the availability of the individual wireless interfaces. For example, if the Wi-Fi network is disabled, the smartphones 10 automatically start communicating with the computer 500 over the cellular data network.

In general, some portion of the persistent memory 74 and/or the SIM card 88 is used to store programs, executable code, and data, etc. In some embodiments, other data is stored in the persistent memory 74 such as audio files, video files, text messages, etc.

The peripherals are examples and other devices are known in the industry such as global positioning system 91 (GPS), accelerometer 94, speakers, USB interfaces, camera 90, microphone 97, Bluetooth transceiver 93, Wi-Fi transceiver 99, image sensors, temperature sensors, health sensors, biometric sensors, etc., the details of which are not shown for brevity and clarity reasons.

The cellular network interface 80 connects the smartphone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the smartphone 10 through the cellular network 68.

For local communications, many smartphones 10 include a Bluetooth transceiver 93, a Wi-Fi transceiver 99, or both. Such features of smartphones 10 provide data communications between the smartphones 10 and data access points and/or other computers such as a personal computer (not shown). In the system for communicating emergency information, the Bluetooth transceiver 93 and/or a Wi-Fi transceiver 99, and/or cellular network interface 80 or any combination, are used to communicate between the safety application 19 running on the smartphone 10 and the computer 500.

Referring to FIG. 3, a schematic view of a typical computer system 500 is shown. The example computer system 500 represents a typical computer system used in the system for communicating emergency information for communicating/controlling the devices (e.g. smartphones 10). This exemplary computer system is shown in its simplest form. Different architectures are known that accomplish similar results in a similar fashion and the present invention is not limited in any way to any particular computer system architecture or implementation.

Although represented as a computer system 500 having a single processor 570, it is fully anticipated that other architectures be used to obtain the same or similar results.

In the example computer system 500 of FIG. 3, a processor 570 executes or runs programs in a random-access memory 575. The programs are generally stored within a persistent memory 541 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 541 is any type, configuration, capacity of memory suitable for persistently storing data, for example, magnetic storage, disk, flash memory, read only memory, battery-backed memory, magnetic memory, etc. The persistent memory 541 (e.g., flash storage) is typically interfaced to the processor 570 through a system bus 582, or any other interface as known in the industry.

In some embodiments, one or more radio transceivers 504 with the antennas 506 are interfaced to the system bus for access by the processor 570 in any way known in the industry (e.g. through any configuration of routers, access points, wiring, etc.). In some embodiments, one or more radio transceivers 508A/508B/508C are interfaced to a local area network (e.g. Ethernet) that interfaces to the computer 500 through a local area network adapter 512 that is connected to the system bus for access by the processor 570 in any way known in the industry (e.g. through any configuration of routers, access points, wiring, etc.). In some embodiments a wired connection is also provided for connection to the internet and to other computers such as those of law enforcement and/or parents/loved ones. In some embodiments, a connection to a phone line is provided for making automated calls to law enforcement personnel and/or parents/loved ones.

In general, some portion of the persistent memory 541 is used to store programs, executable code, dataset 502 including the list of the user devices 440, etc.

Other features/peripherals of the computer 500 (e.g. display, keyboard, mouse, I/O ports, etc.) are not shown for brevity and clarity reasons.

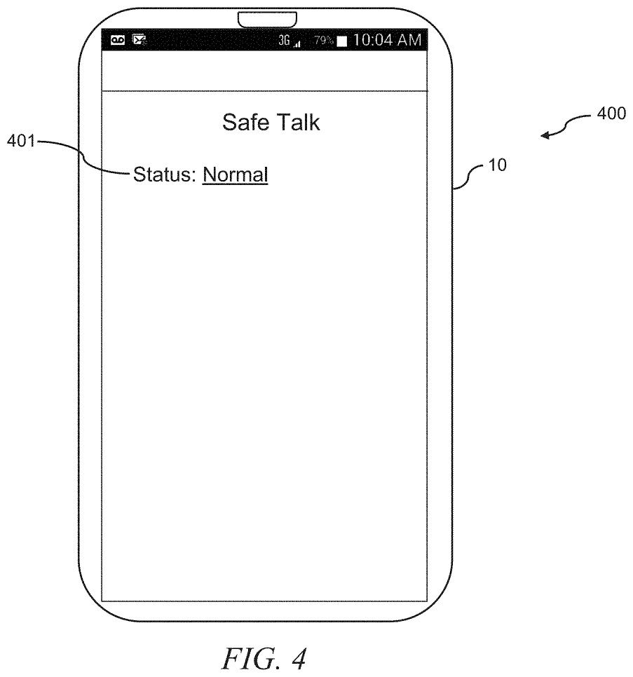

Referring to FIG. 4, a first typical status user interface 400 of the system for communicating emergency information is shown. In this, no issue has been reported, so the status of the incident 401 is normal.

Referring to FIGS. 5 and 5A, typical user interfaces 420/420A of the system for communicating emergency information is shown. In this an alert has been issued. The status of the incident 401 indicates an alert has been issued (e.g. “Active Shooter”). If a potential location of the invader 30 is known, the location 422 is displayed. Note that the display of the user device (e.g. smartphone 10) is dimmed so as to not become a target of the invader 30. Not visible, in some embodiments, the audio of the user device (e.g. smartphone 10) has been muted and, in some embodiments, the vibration is also disabled. Sound and/or vibration in a quiet area (e.g. during hiding) has the potential to alert the invader 30.

Although any number of quick operations 424/425/426/427/428 is anticipated, for brevity and clarity reasons, five quick operations 424/425/426/427/428 are shown. A first quick operation 424 is to be activated if the person of the user device (smartphone 10) has sight of the invader 30. A second quick operation 425 is to be activated if the person of the user device (smartphone 10) is well. A third quick operation 426 is to be activated if the person of the user device (smartphone 10) wants to send a picture or video to the computer 500 and, eventually, to law enforcement and/or parents. A fourth quick operation 427 is to be activated if the person of the user device (smartphone 10) has been wounded or shot and needs medical attention. A fifth quick operation 428 is to be activated if the person of the user device (smartphone 10) wants to call out (assuming they are currently safe) to a predetermined number. In some embodiments, the predetermined number is pre-programmed to the law enforcement personnel, school authorities, parents, etc. In some embodiments, the predetermined number is pre-programmed by the person and/or parent/guardian/loved one.

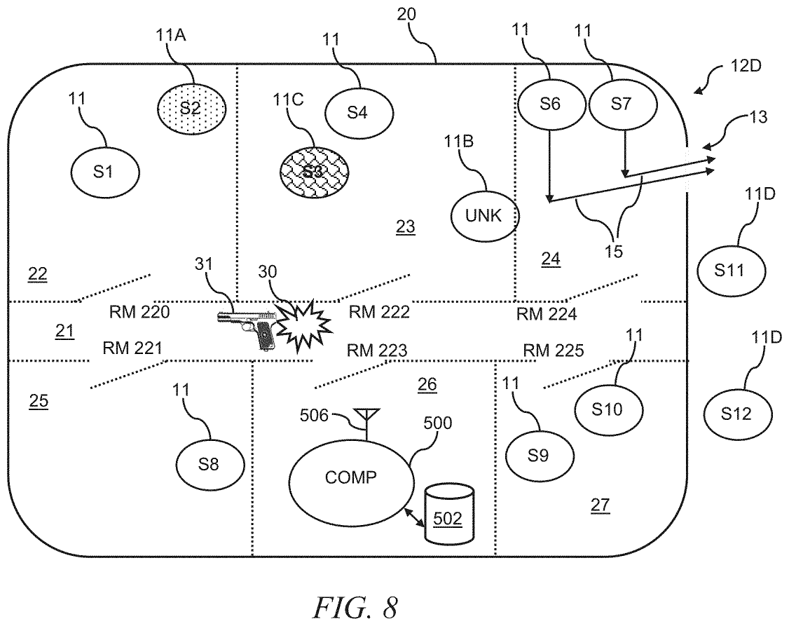

In some embodiments, when a safe escape route 15 is known, an icon 429 is displayed and, selection of the icon 429 will show the safe escape route 15 as displayed on the map 423 (see FIG. 5A) of the large-format map 12D as shown in FIG. 8. In FIG. 5A, the user 17 has activated the icon 429 and a map 423 shows the safe escape route 15 for that user 17.

In FIGS. 6 and 6A, different ways to communicate and recognize smartphones 10 and, hence, users, are shown. In FIG. 6, each user and smartphone 10 (device) has either a phone number (e.g. for sending SMS messages) and/or an address (e.g. for sending email messages). In FIG. 6A, each user and smartphone 10 (device) has an IP address. It is anticipated that each user must register with a service such as a nation-wide service or fixed location service (e.g. school or office) to gain access to the apparatus for communicating emergency information. Through this registration, each user agrees to a privacy policy allowing the apparatus for communicating emergency information to take control of their smartphone 10 (device) when an event occurs, capturing sensor data from their smartphone 10 and communicating directly with their smartphone 10. For example, a school requires parents of each student that has a device (e.g. smartphone 10) to download the safety application 19 and agree with the privacy policy. Those who have not agreed, as tracked by the datasets 440, do not receive protection from the apparatus for communicating emergency information.

Referring to FIG. 6, an exemplary dataset for provisioning of the system for communicating emergency information is shown. The dataset includes a list of the devices 440 of people/users who may be within the building or in the area, though it is anticipated that some people/users may not be in the building or may be away from the area as they may be on vacation, out sick, out for lunch, etc.

In this greatly simplified list, an entry for each person includes the ability to have a phone number, address (e.g. email or application address), a name, status of the safety application 19, and privacy status. Note that there are typically regional rules as to a person's privacy and, in some embodiments, each person/user must agree to the privacy statement associated with the safety application 19 before information regarding the person is presented. Therefore, for example, a field for each person indicates if that person has agreed to the privacy statement and, if so, the system for communicating emergency information will operate as described. If that person has not agreed to the privacy statement, the system for communicating emergency information will operate differently, for example, by not showing the name or identification of the person on the large-format map 12D (see FIG. 8) or not communicating with the user's smartphone 10 (or other device).

Information is shown for several people. A first person 441 has agreed to the privacy policy, installed the safety application 19, and has provided their phone number as a way to contact their user device (e.g. smartphone 10). Another person 442 has not agreed to the privacy policy, has installed the safety application 19, and has provided their phone number as a way to contact their user device (e.g. smartphone 10). Another person 443 has not agreed to the privacy policy, has not installed the safety application 19, and has provided their phone number and has provided a Wi-Fi address as a way to contact their user device (e.g. smartphone 10). A final person 444 has agreed to the privacy policy, installed the safety application 19, and has provided an email address as a way to contact their user device (e.g. smartphone 10), but has not provided a phone number. It is fully anticipated that any form of addressing is anticipated, including MAC addresses, Bluetooth addresses/pairing, phone numbers, email addresses, etc., as long as one or several of the addresses uniquely addresses the user device (e.g. smartphone) of the user and is capable of establishing communications to the safety application 19.

Additionally, other information is optionally maintained for each person such as contact information (e.g. next-of-kin), identification information (e.g. photo, scars, and tattoos), age, sex, allergies, ailments, etc. These are useful should the person be injured, etc.

Referring to FIG. 6A, a second exemplary dataset for provisioning of the system for communicating emergency information is shown. The dataset includes a list of the devices 440 of people who may be within the building or in the area, though it is anticipated that some people may not be in the building or may be away from the area as they may be on vacation, out sick, out for lunch, etc., or their smartphone 10X may be left at home.

In this greatly simplified list, an entry for each person includes a phone number, IP address, a name, status of the safety application 19, and privacy status. Note that there are typically regional rules as to a person's privacy and, in some embodiments, each person/user must agree to the privacy statement associated with the safety application 19 before information regarding the person is presented and communications with the safety application 19 are made. Therefore, for example, a field for each person indicates if that person has agreed to the privacy statement and, if so, the system for communicating emergency information will operate as described. If that person has not agreed to the privacy statement, the system for communicating emergency information will operate differently, for example, by not showing the name or identification of the person on the large-format map 12D (see FIG. 8) or not communicating with the user's smartphone 10 (any device).

Information is shown for several people. A first person 441 has agreed to the privacy policy, installed the safety application 19, and has provided their phone number as a way to contact their user device (e.g. smartphone 10). The IP address of the smartphone 10 of each person is captured during initialization of the safety application 19 and associated with each person. Another person 442 has not agreed to the privacy policy, installed the safety application 19, and has provided their phone number. Another person 443 has not agreed to the privacy policy, has not installed the safety application 19, but has provided their phone number. Since this person has not installed the safety application 19, there is no IP address 449 for this person. A final person 444 has agreed to the privacy policy, installed the safety application 19. It is fully anticipated that any form of addressing is anticipated, including IP addresses, Bluetooth addresses/pairing, phone numbers, email addresses, etc., as long as one or several of the addresses uniquely addresses the user device (e.g. smartphone 10) of the user and is capable of establishing communications to the safety application 19.

The list of devices 440 (and hence users/people) having IP addresses is useful for a regional version of the system for communicating emergency information. For example, any person who downloads the safety application 19 and agrees to the privacy policy will be in a regional list of devices 440. Therefore, if that person and their device (e.g. smartphone 10) enters any establishment or area that is part of the system for communicating emergency information and an event occurs, their device (e.g. smartphone 10) will receive communications as described if an event occurs and they are local to that event. For example, if a football stadium is equipped with Wi-Fi repeaters (radio transceivers 508A/508B/508C) have connection to the system for communicating emergency information (e.g. computer 500 or access to computer 500 and related software), when a registered user enters the stadium and connects to Wi-Fi, that user's IP address will be found in the list of devices 440 and, should an event occur, that user's device (e.g. smartphone 10) will operate as described during the emergency.

In some embodiments, the safety application 19 recognizes the Wi-Fi as being part of the system for communicating emergency information and presents a request to connect when entering the protected space. It is also anticipated that each protected space will have signage indicating that it is protected by the system for communicating emergency information to inform users to connect to the local Wi-Fi network in that space.

Messaging between users of the system for communicating emergency information is also anticipated.

Additionally, other information is optionally maintained for each person such as contact information (e.g. next-of-kin), identification information (e.g. photo, scars, and tattoos), age, sex, allergies, ailments, etc. These are useful should the person be injured, etc.

Referring to FIG. 7, an exemplary program flow of the system for communicating emergency information is shown. The basis of operation of the system for communicating emergency information is that, when an event occurs (e.g. an active shooter), the user device (e.g. smartphone 10) of the people within the building or in the area is placed into an emergency mode by the safety application 19, thereby presenting quick and easy to access operations as well as placing the user device into a mode that helps make the people less noticeable.

The system for communicating emergency information monitors for an alarm 230. An alarm is detected if, for example, an administrator or manager issues an alarm or directly from an alarm button, for example, upon receipt of a fire alarm or an administrator/manager witnessing a firearm, knife, etc. If it is determined that an alarm 230 is detected, one of the first operations is to notify authorities 232. In some embodiments, the authorities (e.g. police, fire department) are notified 232 by a message (e.g. text message), by a dedicated signal, by an automated voice call, etc. Once the authorities have been notified 232, the list of devices 440 is accessed and the first entry on the list of devices 440 is read 234 and an alarm message is transmitted 236 to that entry of the list of devices 440. If that entry is not the last entry on the list of devices 440, then the next entry on the list of devices 440 is read 240 and an alarm message is transmitted 236 to that entry of the list of devices 440. If that entry is the last entry 238 on the list of devices 440, then the alarm is activated. Note that for brevity reasons, retry operations, alternate path communications, and connection logging (e.g. updating the list of devices 440 with connection status) are not shown.

Until the alarm is closed 250, the system for communicating emergency information monitors 248 communications from the user devices. Once the alarm is closed 250, the authorities are notified of such 252. Once the authorities have been notified 252, the list of devices 440 is accessed and the first entry on the list of devices 440 is read 254 and an alarm-off message is transmitted 256 to that entry of the list of devices 440. If that entry is not the last entry on the list of devices 440, then the next entry on the list of devices 440 is read 260 and an alarm-off message is transmitted 256 to that entry of the list of devices 440. If that entry is the last entry 258 on the list of devices 440, then the alarm is inactive and the above repeats looking for another alarm.

Referring to FIG. 7A, a second exemplary program flow of the system for communicating emergency information is shown. The basis of operation of the system for communicating emergency information is that, when an event occurs (e.g. an active shooter), the user device (e.g. smartphone 10) of the people within the building or in the area is placed into an emergency mode by the safety application 19, thereby presenting quick and easy to access operations as well as placing the user device into a mode that helps make the people less noticeable. In this example, a connection-based system is utilized, in that, when the user device (e.g. smartphone 10) is within the building 20 or area covered by the system for communicating emergency information, the user device (e.g. smartphone 10) connects to the computer 500 and, therefore, it is known when the user device (e.g. smartphone 10) is within the building 20 or area.

The system for communicating emergency information monitors for an alarm 230. An alarm is detected if, for example, an administrator or manager issues an alarm or directly from an alarm button, for example, upon receipt of a fire alarm or an administrator/manager witnessing a firearm, knife, etc. If it is determined that an alarm 230 is detected, one of the first operations is to notify authorities 230. In some embodiments, the authorities (e.g. police, fire department) are notified by a message (e.g. text message), by a dedicated signal, by an automated voice call, etc. Once the authorities have been notified 232, the list of devices 440 is accessed and the first entry on the list of devices 440 is read 234 and if the device (e.g. smartphone 10) associated with the first entry on the list of devices 440 is connected 235, an alarm message is transmitted 236 to that entry of the list of devices 440. If that entry is not the last entry on the list of devices 440, then the next entry on the list of devices 440 is read 240 and the above is repeated. If that entry is the last entry 238 on the list of devices 440, then the alarm is now activated. Note that for brevity reasons, retry operations, alternate path communications, and connection logging (e.g. updating the list of devices 440 with connection status) are not shown.

Until the alarm is closed 250, the system for communicating emergency information monitors 248 communications from the user devices. Once the alarm is closed 250, the authorities are notified of such 252. Once the authorities have been notified 252, the list of devices 440 is accessed and the first entry on the list of devices 440 is read 252 and if the device (e.g. smartphone 10) associated with the first entry on the list of devices 440 is connected 255, an alarm-off message is transmitted 256 to that entry of the list of devices 440. If that entry is not the last entry on the list of devices 440, then the next entry on the list of devices 440 is read 260 and the above is repeated. If that entry is the last entry 258 on the list of devices 440, then the alarm is inactive and the above repeats looking for another alarm.

Referring to FIG. 7B, a third exemplary program flow of the system for communicating emergency information is shown. In this, an alarm has been signaled and, therefore, access is provided to information from each smartphone 10 (or other devices) that is registered and/or has agreed to the privacy policy. Such access includes, but is not limited to, any of video, audio, location, movement, and time information from the smartphone 10. For simplicity, the exemplary program flow of FIG. 7B analyzes audio data, though similar analysis is anticipated for video data, motion data, ambient light, etc.

Once an alarm is established, the monitoring analysis scans each smartphone 10 for audio data. In such, the monitoring analysis starts 270 with the 1^{st} smartphone 10 in the list (e.g. dataset 4—40—a list of those that have installed the application and agreed to the privacy policy). This algorithm receives 272 a block of audio from the current smartphone 10 along with any of the location of the smartphone 10 and the time that the audio started at the smartphone 10. The audio is then analyzed 273, looking for specific audio footprints that represent sounds of, for example, gunfire as, for example, shown in FIG. 1C. If this analysis 273 detects 274 the sound of a gunshot, the data (existence of a gunshot, location of the smartphone, time of the gunshot sound, etc.) is recorded 276. If this is not the last smartphone 10 in the list, the next smartphone 10 in the list is selected 280 and the loop 272-278 repeats.

If this is the last smartphone 10 in the list, then if the analysis 273 indicated that any sounds of a gunshot were detected as per having stored at least one record 282, the location of the gunshot is determined. The location is determined through a triangulation algorithm 284. In some embodiments, the triangulation algorithm 284 uses relative volume of the recorded sounds of the gunshot to determine a relative location of the invader 30 (e.g. a louder sound level from one smartphone 10 indicates the invader 30 is closer to that smartphone than a quieter sound level from another smartphone 10). In some embodiments, the time at which the sound of the gunshot was received at each smartphone 10 is used to triangulate the location of the invader 30 (e.g. a gunshot sound arriving at a first smartphone 10 earlier than when the gunshot sound arrives at a second smartphone 10 indicates that the invader is closer to the first smartphone). In some embodiments, a combination of such is used to better triangulate the location of the invader 30.

Once the triangulation algorithm 284 determines the location of the invader 30, the location is transmitted to each smartphone 10, for example, for display and mapping. In such, the transmission starts 286 with the 1^{st} smartphone 10 in the list (e.g. dataset 440—a list of those that have installed the application and agreed to the privacy policy). The location and/or map data is transmitted 288 to the current smartphone 10 in the list. If this is not the last smartphone 10 in the list 290, the next smartphone 10 in the list is selected 292 and the loop 288-290 repeats until the location/map is transmitted to all smartphone 10 on the list.

Referring to FIG. 8, a plan view of a large-format map 12D of the exemplary building utilizing the exemplary system for communicating emergency information is shown. In this example, the building 20 is shown after an alert is activated showing identification and status of each person 11/11A/11B/11C/11D (e.g. Student). As communications is established with each user device (e.g. smartphone 10), in some embodiments, the large-format map 12D is updated with the name or identification of each person 11/11A/11B/11C/11D. In some embodiments, numbers or keywords are assigned to each person 11/11A/11B/11C/11D for privacy reasons as the information being displayed is often sensitive.

Note that two persons/students 11D are shown outside of the boundary of the building 20. It is anticipated that the server 500 will communicate or be reached by a user device (e.g. smartphone 10) and some user devices (e.g. smartphones 10) may not be capable of being reached (e.g. broken, in airplane mode, or turned off) and some may be away from the building 20 (e.g. a student or worker is home, sick).

Note that one person/student 11B is marked as unknown. It is anticipated that the server 500 will communicate or be reached by a user device (e.g. smartphone 10) that is not registered, but it is still possible to know where that user device is located (e.g. through triangulation of radio signals from that user device) and that person/student 11B is recorded on the second map 12B as an unknown user.

As each person 11/11A/11B/11C/11D is contacted, hopefully, each person 11/11A/11B/11C/11D indicates their status such as, “I'm OK” or hopefully not, “I've Been Shot,” as in FIG. 5. Initially, each person 11/11A/11B/11C/11D is displayed to convey a status indicating that communications has been established between the computer 500 and the user device (e.g. smartphone 10) associated with that person 11/11A/11B/11C/11D. In the example of FIG. 8, the status of several persons 11 are shown in one way, indicating that communications has been established between the computer 500 and the user device (e.g. smartphone 10) associated with that person 11 (e.g. a specific color, font, shading, etc.). In the example of FIG. 8, two people 11D are shown in which communications cannot be established. If they are within the building 20, it is not possible to know where they are as their device (e.g. smartphone 10) is not communicating with the computer 500.

As the status of each person 11/11A/11B/11C/11D becomes known (e.g. each person 11/11A/11B/11C/11D operates their user device to indicate their wellbeing), the second map 12B is updated to indicate their status. In the example of FIG. 8, the status of one person 11A is shown in a different way (e.g. a different color, a different font, different shading, etc.), indicating that this person 11A is not well, for example, the person 11A has been shot. The status of another person 11C is shown in a different way (e.g. a different color, a different font, different shading, etc.), indicating that this person 11C is not well for a different reason or this person has sight of the invader 30. Any number of indications is anticipated for any conceived status.

In some embodiments, the large-format map 12D is shared outside of the building 20, institution, or area; sending updates to the large-format map 12D to law enforcement and/or parents and/or loved ones, depending upon privacy laws. In some embodiments, the identification of some or all students is suppressed for privacy reasons, especially if sent to parents and/or loved ones. In some embodiments, instead of names, an identification number is presented. In such, for example with students, the parents know the identification (e.g. student number) of their child but not those of others. In some embodiments, certain details of the large-format map 12D are not shown to parents and/or loved ones, for example, the status of those who have been wounded.

In some embodiments, when a safe escape route 15 is possible (e.g. through a window 13), the safe escape route 15 is displayed on the large-format map 12D and, some or the entire large-format map 12D is displayed on the user devices (smartphones 10) to assist in escape.

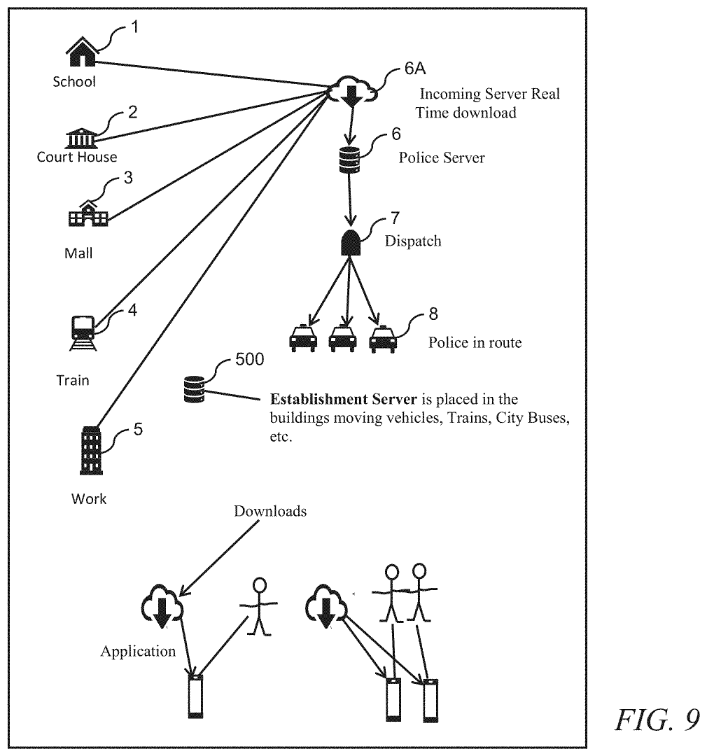

Referring to FIG. 9, Application Software is connecting to an establishment server 500, for example, in a school 1, in a court house 2, in a mall 3, in a train 4, in a work location/office 5, etc. The server 500 sends critical information to the Police Server 6 and Dispatch 7, that allowing real time information to be sent to police 8 on the ground.

The nature of the software system is that the police server software 6A controls the locations and user data collected from the mobile apps. In some embodiments, the establishment server 500 is in any public institution or business, such as banks, malls 3, entertainment venues, or any business that manages user data for location information, and threat information. Such information is collected and sent to the police server software 6A.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for communicating emergency information, the system comprising:
a computer;
a plurality of user devices;
software running on the computer, upon detecting an alarm, the software causing the computer to communicate the alarm to each of the user devices; and
upon receiving the alarm by each user device of the plurality of user devices, software running on the each user devices causes the each user device to set a brightness of a display of the each user device to a low brightness and to disable audio output of the each user device, the software running on the each user devices further causes the each user device to display a status of the alarm and to provide quick action icons.

2. The system of claim 1, wherein the user device is a smartphone.

3. The system of claim 1, further comprising after receiving the alarm by the each user device, the software running on the each user devices causes the each user device to record audio from a microphone of the each user device.

4. The system of claim 3, further comprising the software running on the each user devices causes the each user device to read a device location of the each user device and to send the audio and the device location to the computer.

5. The system of claim 4, further comprising the software running on the computer causes the computer to receive the audio and the device location from a plurality of the user devices and to triangulate a location of a gunshot from the audio and the device locations that were received from a plurality of the user devices.

6. The system of claim 5, further comprising the software running on the computer causes the computer to send the location of the gunshot to the each user device.

7. The system of claim 5, further comprising the software running on the computer causes the computer to further use a volume level of the gunshot to triangulate the location of the gunshot from the audio and the device locations that were received from a plurality of the user devices.

8. The system of claim 5, further comprising the software running on the computer causes the computer to display a map that includes the location of the gunshot and the location of the each user device.

9. The system of claim 8, wherein the quick action icons include a first icon for requesting an escape map, a second icon for indicating that the shooter is near the each user device, a third icon for indicating that the user of the each user device is safe, and a fourth icon for indicating that the user of the each user device has been shot.

10. The system of claim 8, wherein upon activation of any of the quick action icons, the software running on the each user devices causes the each user device to send a transaction to the computer indicating which of the quick action icons were activated and upon receiving the transaction at the computer, the software running on the computer causes the computer to update the map to include an indication of which quick action icon was activated and to display the map.

11. A method for communicating emergency information, the method comprising:
loading a safety application on a user device;
upon detecting an alarm, communicating the alarm from a computer to the user device; and
upon receiving the alarm by the safety application running on the user device, the safety application setting a brightness of a display of the user device to a low brightness and the safety application disabling audio output of the user device, the safety application further displaying a status of the alarm on the display and providing quick action icons on the display.

12. The method of claim 11, further comprising after receiving the alarm by the user device, the safety application running on the user device recording an audio track from a microphone of the user device.

13. The method of claim 12, further comprising the safety application reading a device location of the user device and sending the audio track and the device location to the computer.

14. The method of claim 13, further comprising receiving at the computer, the audio track and the device location from the user device and triangulating a location of a gunshot from the audio track and the device location that was received from a plurality of the user devices.

15. The method of claim 14, further comprising the computer sending the location of the gunshot to the user device.

16. A system for communicating emergency information, the system comprising:
a computer;
a plurality of user devices;
software running on the computer, upon detecting an alarm, the software causing the computer to communicate the alarm to each of the user devices;
upon receiving the alarm by each user device of the plurality of user devices, software running on the each user device causes the each user device to set a brightness of a display of the each user device to a low brightness, to disable audio output of the each user device, to display a status of the alarm, to initiate capture of audio from a microphone of the each user device, to read a device location of the each user device from a global positioning subsystem of the each user device; and
the software running on the each user device analyzes the audio from the microphone and looks for a specific sound and upon detecting the specific sound, the software running on the each user device transmits an indication of the specific sound and at least one of the device location, a time of the specific sound, and a volume level of the specific sound to the computer.

17. The system of claim 16, wherein the specific sound is a sound of a gunshot.

18. The system of claim 17, further comprising the software running on the computer causes the computer to use the device location as received from a plurality of the user devices to triangulate a location of the sound of the gunshot.

19. The system of claim 17, further comprising the software running on the computer causes the computer to use the volume level as received from a plurality of the user devices of the gunshot to triangulate the location of the gunshot.

20. The system of claim 18, further comprising the software running on the computer causes the computer to display a map that includes the location of the gunshot and the location of the each user device.
